(19) United States
(12) Patent Application Publication
(10) Pub. No.: US 2001/0054354 A1
(43) Pub. Date: Dec. 27, 2001

(54) Direct turbine air chiller/scrubber system

(76) Inventors: Ned P. Baudat, Sugar Land, TX (US); Franklin W. Richardson, Houston, TX (US)

Correspondence Address: PAUL S MADAN, MADAN, MOSSMAN & SRIRAM, PC, 2603 AUGUSTA, SUITE 700, HOUSTON, TX, 77057-1130, US

(21) Appl. No.: 09/884,181

(22) Filed: Jun. 18, 2001

Related U.S. Application Data
(60) Provisional application No. 60/213,352, filed on Jun. 21, 2000.

(51) Int. Cl. B01D 53/14

(52) U.S. Cl. 95/214; 95/228; 96/355

(57) ABSTRACT

The subject invention involves an apparatus and method for chilling and scrubbing air to be used in a gas turbine. The apparatus includes at least one spray scrubbing area, where the water is collected, recirculated, and filtered. Cooling is accomplished with at least one evaporative cooling media, such as a packed bed. Optionally the water sprayed into contact with the air may be chilled. At least one drift eliminator is employed prior to the air leaving the apparatus to at least partially dehumidify it prior to use by the gas turbine. The turbine inlet air may be cleaned of solid contaminants, such as sand, dirt, and ash, and of entrained liquid contaminants such as seawater. Under high ambient temperature and relative humidity conditions, this system will also recover fresh water from the air by condensation. The power available from gas turbine refrigeration compressor drivers may be increased by this direct contact cooling of the turbine inlet air. When applied to a base-load LNG plant in a Middle Eastern desert location where seawater is used for the final heat sink, it is estimated that this apparatus can provide a net power increase in the range of 8 to 10 percent.

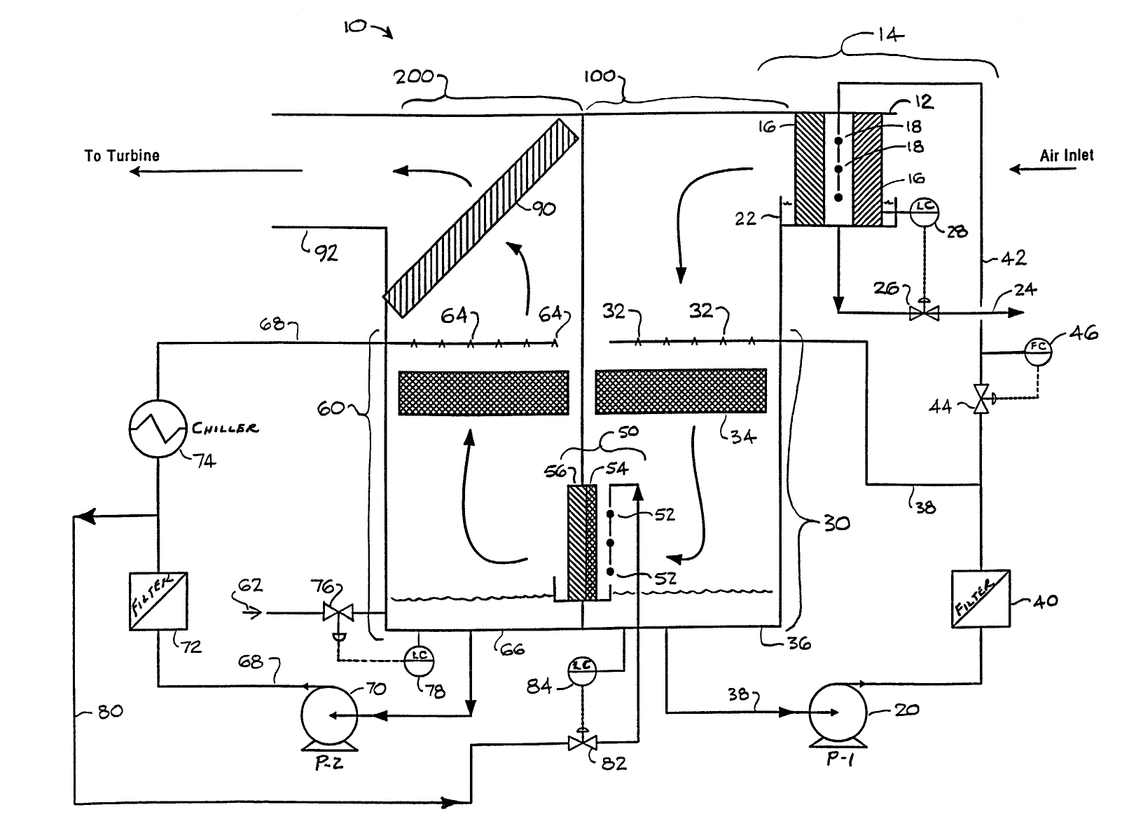

### FIELD OF THE INVENTION

The present invention relates to methods and apparatus for scrubbing and chilling air, and in a further embodiment relates to methods and apparatus for chilling and scrubbing air of contaminants where the air is provided as clean, cool inlet air to a gas turbine.

### BACKGROUND OF THE INVENTION

The operation of gas turbines is well known. In the initial phase of a gas turbine's cycle, an air compressor stage consumes approximately 60 percent of the work done by the power turbine. As such, the efficiency of the compression stage has a large effect on the efficiency of the whole cycle. To maintain peak efficiency, the compressor would have to be kept extremely clean and the blades would have to maintain their original design profile and surface smoothness. However, with these compressors pulling in ambient air laden with particulate material, and in some environments salt brine, the desired level of cleanliness cannot be maintained. The compressor blades are eroded by the larger particles and the brine salts. Smaller particles stick to the blades changing the shape and smoothness of the blades. This is called “fouling”. Both the small particles and corrosive volatiles work to corrode the blade surface. Gas turbines, therefore, require clean air to prevent fouling, corrosion, and erosion of the gas turbine internal components such as the compressor blades.

The prior method for cleaning inlet air to gas turbines is to use a combination of filters for removing particulates in the air. However, air filters, alone, have not been successful in eliminating the fouling, erosion, and corrosion damage to the compressor. The result is loss of efficiency and damage to expensive compressor blades. The air contaminants in either particulate or gaseous form penetrate even the best filter systems available, and enter the compressor section of a gas turbine engine. The particulates and entrained brine that make their way to the compressor will erode the compressor blades or stick to the blades which cause fouling and often corrosion and pitting. The corrosion can weaken a blade to the failure point or, as a minimum, degrade airfoil performance. In addition, both solid and gaseous contaminants that make it through the compressor will enter the turbine section, causing a buildup of material that degrades the machine performance and causes hot corrosion of the hot end parts. The costs to a gas turbine operator from degraded performance and worn and/or corroded parts replacement due to contaminated inlet air can exceed a million dollars a year per turbine.

Further, when a gas turbine is driving a process gas compressor, currently it is not possible to allow the full effective use of the process gas compressor under all weather seasons and conditions. In hot weather, the compressor must operate at its highest head and under its lowest power condition. If the compressor is designed to operate under this condition, it does not have the capacity to operate at full available gas turbine power in cold weather because it will simply not be big enough; i.e. it cannot be designed for the required flow. In other words, if the compressor is designed for the cold weather conditions, the gas turbine cannot develop enough power in hot weather to keep the compressor out of surge. To summarize the problem, temperature extremes at some gas turbine facilities greatly affect the output of the facility. One such facility could be an LNG plant using process gas compressors for refrigeration in the LNG process.

Prior systems include those such as described in U.S. Pat. No. 4,926,620 which discloses a process and apparatus for cleaning contaminants from inlet air passing to a gas turbine, including contacting the air with a stream of water at a rate and spray pattern sufficient to reduce contaminants present in the air. The water scrubbing action of the process and apparatus removes gaseous and solid contaminants which can cause corrosion and erosion of turbine parts and which can cause buildup of solid materials in the turbine.

Somewhat related is U.S. Pat. No. 5,405,590 which describes an off-gas quencher and solid recovery scrubber unit which includes a wet flue gas scrubber which has the dual responsibilities of lowering the temperature of the inlet hot gas entering through the scrubber and trapping contaminants from the gas stream into the liquid stream. The hot exhaust gases are first cooled by evaporating the liquid scrubber solution. The contaminants of the exhaust gas are neutralized by a suitable reagent such as sodium hydroxide and the product is collected in the scrubbing solution. Since the solution is continuously recycled, the concentration of the scrubbing agent will be diminished as the scrubbing proceeds, while the concentration of the scrubbing product in the solution will rise to the solubility limit of the product. The scrubbing products start to precipitate and are collected at the bottom of the scrubber and are withdrawn. The scrubbing reagents are continuously replenished to the scrubber. The secondary scrubber is another wet scrubber, which uses reagents/water from spray nozzles to scrub off any contaminants that might have escaped the solid recovery scrubber. In addition, the exhaust gas entering the secondary scrubber is cooled below its dew point, which results in condensation of water in the scrubber.

Particulate laden gas, especially those gases carrying particulates having a size in the micron or submicron range, can have the particulates removed by humidifying the gas with water and thereafter subjecting the gas to indirect contact heat exchange sufficient to provide an energy transfer for water vapor condensation of at least 5 horsepower per 1000 cfm (3.7 kW per 28 m³/min.), according to U.S. Pat. No. 4,284,609. Heat exchange is accomplished by passing the gas downwardly through an exchange element having smooth and vertical gas passages of a relatively large dimension.

U.S. Pat. No. 4,285,702 discloses a method of recovering water from atmospheric air. During an adsorption phase, cool, humid air is transported through a water-adsorbent material for adsorption of water vapor therefrom and wherein during a desorption phase warmer, drier air is transported through the adsorbent material for pickup of water from said adsorbent material. The desorption phase comprises the steps of generating a first air stream in a closed-loop path through a heater for heating the first air stream and thence to the adsorber material and back through the heater, continuing the step for a predetermined time, generating a second air stream by diverting a portion of the first air stream for circulation from the adsorber material through a condenser for yielding water therefrom by condensation, and joining the second air stream to the first air stream after passage of the second air stream through the condenser whereby the second air stream may be heated by the heater and passed through the adsorbent material.

It would thus be desirable if an apparatus and method could be devised to more completely remove contaminants in inlet air prior to use by the compressor of a gas turbine. It is further desirable to provide more uniform operating conditions for the gas turbine.

### SUMMARY OF THE INVENTION

Accordingly, it is an object of the present invention to provide a system for chilling and scrubbing air just prior to its entry to the compressor of a gas turbine for longer turbine life.

Another object of the present invention is to provide a direct turbine air chilling and scrubbing system that may produce more and higher quality water than it uses.

A further object of the invention is to chill gas turbine inlet air to augment power production.

In carrying out these and other objects of the invention, there is provided, in one form, an air chiller and scrubber system having an air inlet; at least one spray scrubbing area with at least one plurality of water spraying nozzles to contact the air with water to cool the air and to transfer contaminants from the air to the water; a water collection reservoir; a pump for circulating the water from the collection reservoir and recycling at least a portion thereof to the nozzles; and at least one filter between the water collection reservoir and the nozzles for removing contaminants from the water. The system also has at least one drift eliminator prior to an air outlet.

### BRIEF DESCRIPTION OF THE DRAWINGS

The FIGURE is a schematic representation of one example of a direct turbine air chiller and scrubber system of the invention.

It will be appreciated that the FIGURE is not to scale or proportion as it is simply a schematic for illustration purposes.

### DETAILED DESCRIPTION OF THE INVENTION

The invention described herein will accomplish at the same time, with the same apparatus, all of the following goals, and more:

1. Chilling the gas turbine inlet air for power augmentation;

2. Allowing higher and more constant LNG production throughout all weather conditions;

3. Cleaning the inlet air to provide longer turbine life;

4. Scrubbing and cleaning the air to the turbine to reduce mechanical filter costs and prolong the time between turbine blade washing, and thereby reduce maintenance costs; and

5. Producing higher quality water for the system.

There is synergy in accomplishing all of the goals at once; for example, unit costs can be reduced. A preferred embodiment of the invention is to use a common inlet air system for all of the major turbine drivers in a process plant, which are usually installed close together in one area. This will achieve economy of scale for the water circulation and filtration. It will also achieve a lower air velocity in the cooling and cleaning section of the invention such that conventional low cost vapor/liquid contacting devices can be used without incurring high inlet air pressure drops. Low air pressure drops are required to avoid turbine power losses. Lower air velocity is achieved by using a large common structure of high cross-sectional area for the inlet air flow. Prior devices have focused on the use of specially designed devices for the air/water contact to reduce the air pressure drop. Such devices are not necessary in the inventive system.

In one non-limiting embodiment, the inventive system is run at a temperature low enough to produce water at almost all times. This has a value in those same climates where it is cost effective to use air chilling for power generation.

Chilling in the inventive system is accomplished at least by humidifying the air through evaporating water, thereby cooling it. This initial type of chilling may be supplemented by chilling the water used to humidify the air.

It will be appreciated that the terms “chilling” and “cooling” are used synonymously herein to refer to lowering the temperature of air or water. The term “scrubbing” refers to removing brine salts, gases (other than O₂ and N₂) and particulates from the air. “Humidify” means adding water to the air, i.e. increasing the humidity of the air, while “dehumidify” refers to removing water from the air. An air stream of 100% relative humidity cannot be further humidified, although such air can entrain or contain more water as mist, fog, or the like. Such entrainment is not necessarily anticipated in the air streams within the direct turbine air chiller and scrubber system of this invention, but such mists or fogs are not expected to be detrimental to the apparatus or method of the system.

Another preferred application embodiment is to use the inventive system in an LNG or gas processing plant where one of the gas turbines drives a propane refrigeration compressor, and to use this propane refrigeration to chill the circulating water. It will be appreciated that the air chiller and scrubber system of this invention may be used in connection with all turbine types, including those which drive a refrigerant compressor where the refrigerant can be propane, ethylene, methane, a mixed refrigerant, fluorocarbon refrigerant, etc. A propane refrigeration compressor is used herein as a non-limiting example. The incremental cost for such refrigeration when added to a large existing system is very low. Indeed, the invention increases the refrigeration capacity of a facility using gas turbines for power, and thereby the facility output or capacity, for a relatively small capital investment. The power available from the gas turbine refrigeration compressor drivers is increased by direct contact cooling of the turbine inlet air with chilled water. The power increase available due to air cooling is expected to be four to ten times greater than the power required to do the chilling, depending upon the ambient conditions. The water can be chilled by refrigeration either from the process at the facility or by an added refrigeration system, which may be done relatively easily.

The economy of scale can be applied to an LNG plant, for example, by using a single water circulating system for all of the gas turbines (two or more turbines, depending upon which liquefaction process is used) in the process plant.

Another advantage of the inventive system, when used in an LNG or gas processing plant with propane refrigeration, is to allow the full effective use of the propane compressor under all site weather conditions and to achieve a higher annual production. The problem is that without air cooling, in hot weather, the propane compressor must operate at its highest head under its lowest power condition. The compressor, when designed to operate under this condition, does not have the capacity to operate at full available gas turbine power in cold weather because it is simply not big enough—that is, it cannot be designed for the required flow. In other words, if the system is designed for the cold weather conditions, the gas turbine cannot develop enough power during hot weather to keep the compressor out of surge. The only solution is to build a smaller compressor that limits plant capacity in cold weather and reduces annual capacity. This is undesirable, of course, and the invention enables the inlet air to stay at a fairly constant temperature year-round, so that the gas turbine can be designed for one set of conditions and operate at optimum efficiency at those conditions.

The invention further concerns an apparatus and method where gas turbine inlet air is scrubbed of contaminants, such as sand, dirt, and ash, as well as entrained liquid contaminants such as seawater, and also cooled in order to provide clean, cool air to the turbine. It is unique in that no other filtration system is required, and the air is both scrubbed of contaminants and cooled—either through evaporation or with chilled water or both. In a basic design, two or more stages of contact/cleaning are used. In one non-limiting preferred embodiment, the basic design consists of a four-stage system, as will be described.

Referring to the FIGURE in general terms, air enters the inlet 12 of the direct turbine air chiller and scrubber system 10 and is drawn into a spray scrubbing area 14 composed of a series of drift eliminators 16 and a plurality of water spraying nozzles 18 which provide a water scrubbing medium. The plurality of water spraying nozzles 18 may also be termed a “set”, “bank” or “group” of spraying nozzles 18. Water spraying nozzles 18 would preferably spray in between drift eliminators 16. This spray scrubbing area 14 removes the basic contaminants from the air and begins the humidification/cooling process through evaporation. The scrubbing area 14 uses a recirculating pump 20 to provide the water quantity for cleaning through supply line 42. In an optional embodiment of the invention, the supply of water to spray scrubbing area 14 is regulated by valve 44 in response to flow controller 46 to help keep delivery pressure to nozzles 18 relatively constant.

Further, the orientation of the nozzles 18 relative to the air flow in scrubbing area 14 is crossflow. It will be appreciated that in various portions of the system, the direction of the water relative to the air flow is shown as cocurrent, countercurrent or crosscurrent, but that the invention is not necessarily limited to the sequence discussed in the text or depicted in the drawings, and that as one may find that more or less stages than depicted in the drawings and discussed in the text may be advantageous, one may also change the sequence and direction of the water/air contact at any stage in a planned or arbitrary fashion and still be within the scope of the invention.

In addition, a plurality of make-up spray nozzles 32 may be used to provide secondary cleaning. The water blowdown from the first stage (generally spray scrubbing area 14) is used to control the salinity of the second stage 30 if the chilling is accomplished only through evaporation, or to provide total blowdown from the system 10 if chilled water is used to cool the air below the ambient wet bulb temperature. “Blowdown” simply refers to the water blown down and that falls down the spray scrubbing area 14, chamber 100 and chamber 200 into reservoirs 22, 36 and 66, respectively. Blowdown will not include all of the water used by the system 10, but will be a percentage thereof and will be a function of the solids removed. Water containing contaminants collects in first water collection reservoir 22, which is drained through drain line 24 via valve 26 as regulated by level controller 28. Drain line 24 ultimately takes the water to waste disposal or clean-up for reuse.

The second stage 30 consists of a secondary or make-up nozzles 32 next contacting the air in a cocurrent flow orientation through an evaporative cooling media 34 in order to further humidify and cool the air as well as to further scrub particulates from the air. Evaporative cooling media 34 may be any device or structure that cools or chills the air through the evaporation of water thereon. Suitable evaporative cooling media include, but are not necessarily limited to, packed beds, specialized humidification type media, wood or plastic slat top fill, panels or grids of various shapes and materials, including porous materials. Particulates and contaminants are further transferred to the water that accumulates in second water collection reservoir 36 and is recirculated by pump 20 via recirculation line 38. Second water collection reservoir 36 catches all water in first chamber 100. Particulates and contaminants are removed from the water by one or more removable filters 40. Filters 40 for removing contaminants and particulates from water are lower in capital and operating costs, and are more efficient than, air filters used to remove particulates and contaminants directly from air. Further, a higher degree of cleaning may be provided.

Third stage 50 may utilize water from the fourth stage 60 to next contact the air on a crossflow basis through a plurality of spray nozzles 52 on at least one evaporative cooling media 54 and a drift eliminator 56 behind the cooling media 54. This utilization of essentially pure water from the fourth stage 60 (blowdown from second chamber 200) further reduces carryover of particulates and results in the air going to the fourth stage 60 being approximately 100% saturated with water and having essentially no solid contaminants.

Fourth stage 60 contacts the air in a countercurrent flow from a plurality of spray nozzles 64 with chilled water that has been condensed from the air, or from make-up water from a source of controlled purity 62. If the system 10 is such that only evaporative chilling is utilized, this stage 60 would be a final scrubbing area with the evaporation occurring in the first two stages, 14 and 30, and make-up water to those stages would come from a source of general water purity, while any make up water to the fourth stage 60 would be of higher purity water 62.

Fourth stage water would be accumulated in third water collection reservoir 66 and recirculated in fourth stage recirculation line 68 via pump 70, through one or more removable filters 72, and then optionally chilled in chiller 74. High purity make-up water 62 would be admitted as necessary through valve 76 under direction of level controller 78, which detects the level in third water collection reservoir 66.

As noted, third stage 50 is supplied by water from the fourth stage 60 via recirculation line 80 through valve 82 as regulated by level controller 84 which monitors the level in second water collection reservoir 36.

In a preferred embodiment of the invention, a final drift eliminator 90 would provide the last clean-up in order to eliminate any water carryover to the turbine of the chilled, scrubbed air exiting air chiller and scrubber system 10 at outlet 92. In general, the water used in the system 10 moves in a direction countercurrent to the air flow, generally decreasing in purity from water purity source 62 toward first stage 14, as it removes contaminants and impurities from the air.

As noted, the main goals of the invention are to chill and scrub the air prior to its input to a gas turbine. This can be accomplished either by humidification and/or dehumidification. Most of the humidification is expected to be done in first stage 14, second stage 30 and third stage 50. Dehumidification is performed by the drift eliminators 16, 56, and 90. If a chiller 74 is used to chill the high purity water used in the fourth stage 60, in one non-limiting embodiment, the water is chilled to 50° F. (10° C.). Alternatively, the water in fourth stage 60 may be at 70° F. (21° C.), where the water sprayed in second stage 30 may be at 85° F. (29° C.). These temperatures are merely suggested for illustration purposes and are not intended to limit the invention in any way. The chiller 74 may employ high stage propane, Freon, or other conventional refrigeration fluids.

In order to give a general idea, without limiting the invention in any way, one unit of the inventive air chiller and scrubber system 10 may measure approximately 25 feet (7.6 m) wide, 50 feet (15 m) deep, and 45 feet (14 m) tall. On a Frame 6 gas turbine, this system would process a total of approximately 1.3 million pounds (5.9×10⁵ kg) of air per hour. One unit 10 may be expected to cycle approximately 1,000 gpm (3.8 m³/min.) through second stage recirculation line 38, whereas approximately 2,500 gpm (9.5 m³/min.) could be recycled through fourth stage recirculation line 68. These non-limiting dimensions and other parameters of the system such as flow rates for supply line 42 and recirculation line 80 will have to be specified for each system and will vary from job to job. Thus, such values cannot be provided in general.

The invention combines the advantages of evaporative and indirect cooling (with a separate heat exchanger), and allows constant facility output and a higher average facility output, at a relatively small additional cost. When the method and apparatus of this invention is applied to a base-load LNG plant in a Middle Eastern desert location where seawater cooling is used as the final heat sink, the invention can provide a net power increase in the range of 8 to 10 percent. This increase will depend on the actual dry bulb and web bulb and final heat sink cooling temperatures at the specific site. The net power increase is the gain in power from the air cooling less the new power required to chill the water and additional duct losses. The invention allows the plant, with the same installed turbines, to be designed to produce 8 to 10% more annual average LNG, and furthermore, to produce that LNG at essentially the same rate year around, rather than more in cold weather and less in hot weather. The required flexibility for this increase can be designed into the LNG plant refrigeration systems.

At the location proposed above, this invention will, most of the time, particularly if chilling is used, recover water from the air by condensation, and be a net producer of fresh water. The amount of this water varies greatly with the ambient humidity and dry bulb temperature. During periods of low humidity and high temperature, water will be consumed by the system. A water storage tank can be provided to accumulate water during periods of high ambient humidity, export it as allowable, and then feed it back to the operating system during dry periods. Temperature and flow measurements are provided to tell the system operators exactly how much water is being produced or consumed at any time.

It is expected that the invention can be used at LNG base-load liquefaction plants, and at any gas turbine facility where the air inlet temperature varies greatly, e.g. power plants, gas plants, refineries, and the like.

In the foregoing specification, the invention has been described with reference to specific embodiments thereof, and has been demonstrated as effective in providing apparatus and procedures for cooling and scrubbing air, particularly air to be used by a gas turbine. However, it will be evident that various modifications and changes can be made thereto without departing from the broader spirit or scope of the invention as set forth in the appended claims. Accordingly, the specification is to be regarded in an illustrative rather than a restrictive sense. For example, there may be other ways of configuring and/or operating the equipment differently from those explicitly described and shown herein which nevertheless fall within the scope of the claims. More specifically, it will be appreciated that the sequence of scrubbing and chilling may be different from that illustrated and described, yet still accomplish the purposes of the invention. Other embodiments may have water collection, pumping, filtration, and recirculation designs that are different from those shown and discussed.

We claim:

1. An air chiller and scrubber system comprising:
a) an air inlet;
b) at least one spray scrubbing area having
i) at least one plurality of water spraying nozzles to contact the air with water to cool the air and to transfer contaminants from the air to the water;
ii) a water collection reservoir;
iii) a pump for circulating the water from the collection reservoir and recycling at least a portion thereof to the nozzles; and
iv) at least one filter between the water collection reservoir and the nozzles for removing contaminants from the water;
c) at least one evaporative cooling media;
d) at least one drift eliminator prior to
e) an air outlet.

2. The air chiller and scrubber system of claim 1 where the at least one drift eliminator is a last drift eliminator and where the plurality of water spraying nozzles are a first plurality of water spraying nozzles, and further comprising at least a second plurality of water spraying nozzles, and at least a first drift eliminator, where the first drift eliminator is placed at a position selected from the group consisting of:
a) between the air inlet and the second plurality of water spraying nozzles, and
b) between the second plurality of water spraying nozzles and the air outlet.

3. The air chiller and scrubber system of claim 1 further wherein least one plurality of water spraying nozzles is located adjacent an evaporative cooling media.

4. The air chiller and scrubber system of claim 1 further comprising at least two pluralities of water spraying nozzles, each adjacent an evaporative cooling media.

5. The air chiller and scrubber system of claim 1 where at least one plurality of water spraying nozzles sprays countercurrent to the air flow.

6. The air chiller and scrubber system of claim 1 where at least one plurality of water spraying nozzles are a first plurality of water spraying nozzles and sprays cocurrent to the air flow, and where the system further comprises a second plurality of water spraying nozzles that sprays countercurrent to the air flow.

7. The air chiller and scrubber system of claim 1 further comprising a chiller for chilling the water supplied to at least one plurality of water spraying nozzles.

8. An air chiller and scrubber system comprising:
a) an air inlet;
b) at least one spray scrubbing area having
i) at least one plurality of water spraying nozzles to contact the air with water to cool the air and to transfer contaminants from the air to the water, where at least one plurality of water spraying nozzles sprays countercurrent to the air flow;
ii) a water collection reservoir;
iii) a pump for circulating the water from the collection reservoir and recycling at least a portion thereof to the nozzles; and
iv) at least one filter between the water collection reservoir and the nozzles for removing contaminants from the water;
c) at least one evaporative cooling media;
d) at least one drift eliminator prior to
e) an air outlet; and
f) a chiller for chilling the water supplied to at least one plurality of water spraying nozzles.

9. The air chiller and scrubber system of claim 8 where the at least one drift eliminator is a last drift eliminator and where the plurality of water spraying nozzles are a first plurality of water spraying nozzles, and further comprising at least a second plurality of water spraying nozzles, and at least a first drift eliminator, where the first drift eliminator is placed at a position selected from the group consisting of:
a) between the air inlet and the second plurality of water spraying nozzles, and
b) between the second plurality of water spraying nozzles and the air outlet.

10. The air chiller and scrubber system of claim 8 wherein at least one plurality of water spraying nozzles is located adjacent an evaporative cooling media.

11. The air chiller and scrubber system of claim 8 further comprising at least two pluralities of water spraying nozzles, each adjacent an evaporative cooling media.

12. The air chiller and scrubber system of claim 8 where at least one plurality of water spraying nozzles are a first plurality of water spraying nozzles and sprays cocurrent to the air flow, and where the system further comprises a second plurality of water spraying nozzles that sprays countercurrent to the air flow.

13. A method for chilling and scrubbing air in a system, the method comprising:
a) drawing air in through an air inlet;
b) contacting the air with water at least once to cool the air and to transfer contaminants from the air to the water;
c) collecting the water;
d) removing the contaminants from the water;
e) chilling the air with at least one evaporative cooling media;
f) removing at least a portion of the water from the air by contacting the air with at least one drift eliminator; and
g) passing the air through an air outlet.

14. The method of claim 13 further comprising chilling the water prior to contacting the air with it.

15. The method of claim 13 further where contacting the air with water occurs at least twice.

16. The method of claim 13 where chilling the air with an evaporative cooling media occurs at least twice.

17. The method of claim 13 where removing at least a portion of the water from the air by contacting the air with a drift eliminator occurs at least twice.

18. The method of claim 13 further comprising recirculating at least a portion of the water of step d) to step b).

19. The method of claim 13 further comprising recovering more water from the system than is put into the system.
